(19) United States
(12) Patent Application Publication
(10) Pub. No.: US 2013/0040280 A1
(43) Pub. Date: Feb. 14, 2013

(54) WALL MOUNT COVER

(71) Applicant: DON LUPINETTI, Pittsford, NY (US)

(72) Inventor: DON LUPINETTI, Pittsford, NY (US)

(21) Appl. No.: 13/584,793

(22) Filed: Aug. 13, 2012

Related U.S. Application Data
(60) Provisional application No. 61/523,334, filed on Aug. 13, 2011.

(51) Int. Cl. B43L 1/00; H02G 3/14

(52) U.S. Cl. 434/421; 220/241

(57) ABSTRACT

A wall mount cover comprising a front face; a writing surface disposed on the front face; a writing utensil disposed adjacently to the writing surface; a receiving hook or tray positioned beneath the writing surface; and a set of screw holes on a backside of the wall mount phone cover, where the screw holes enable a user to fasten the cover to a wall mount. The writing surface may be a dry erase board or a notepad with the coordinating writing utensil. Additionally, the front face may include a receiving hook to provide a resting location for a user's smart phone.

### CROSS REFERENCE TO OTHER APPLICATIONS

This application claims priority to U.S. Provisional Application Ser. No. 61/523,334 filed on Aug. 13, 2011.

### BACKGROUND OF THE INVENTION

1. Field of the Invention

The present invention relates to a wall mount cover to replace a vacant phone jack cover with a functional wall mount.

2. Description of Related Art

Nowadays, with the exponential growth of cellular phones and smart phones, home telephones are becoming obsolete. Many new construction homes are no longer even providing phone lines in the structures based on the fact that so few families and consumers are using the land lines. In older construction homes this leaves a phone mount that is no longer needed and essentially becomes an eye sore as simply a plastic covering on the wall. In the current market there are limited alternatives to wall mount covers that are aesthetically pleasing as well as serving a practical purpose. In an attempt to fix unsightly phone jacks that are vacant, often a contractor or handy man is required to remove and cover the hole, resulting in a significant cost investment from the homeowner.

It would be desirable in the art to provide a wall mount cover that serves a functional purpose. It would also be beneficial for the wall mount cover to providing a means to support the cellular and smart phones currently available on the market.

### SUMMARY OF THE INVENTION

In view of the foregoing disadvantages inherent in the prior art, the general purpose of the present invention is to provide a wall mount cover, configured to include all of the advantages of the prior art, and to overcome the drawbacks inherent therein.

Accordingly, an object of the present invention is to provide a wall mount cover which includes a writing surface and writing utensil for a functional message writing center on a user's wall.

Another object of the present invention is to provide a wall mount cover that accommodates a cell phone or smart phone thereby providing a safe, resting station for the user to place their personal phone.

To achieve the above objects, in an aspect of the present invention, a wall mount cover is described comprising a front face; a writing surface disposed on the front face; a writing utensil disposed adjacently to the writing surface; a receiving hook positioned beneath the writing surface; and a set of screw-remove holes on a backside of the wall mount phone cover, where the screw-remove holes enable a user to fasten the cover to a wall phone mount. The writing surface may be a dry erase board or a notepad with the coordinating writing utensil. Additionally, the front face may include a receiving hook to provide a resting location for a user's smart phone and a small tray for pens.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A depicts a perspective view of a wall mount cover in accordance with an exemplary embodiment of the present invention;

FIG. 1B depicts a rear perspective view of a wall mount cover in accordance with an exemplary embodiment of the present invention; and

FIG. 1C depicts a top view of a wall mount cover in accordance with an exemplary embodiment of the present invention.

Like reference numerals refer to like parts throughout the description of several views of the drawings.

### DETAILED DESCRIPTION OF THE DRAWINGS

The present invention relates to a wall mount cover to replace a vacant phone jack with a functional wall mount. The wall mount cover includes a writing surface equipped with a writing utensil to maximize the intended use of the phone mount. The wiring surface may be a dry erase board or a notepad for quick and easy message writing. The wall mount cover is typically utilized for social environments such as kitchens and offices areas, since it increased communicability by allowing users to post desired statements for others to receive. Additionally, the wall mount cover offers users the secondary option of utilizing the cover as a docking station or resting platform for a cellular phone or smart phone.

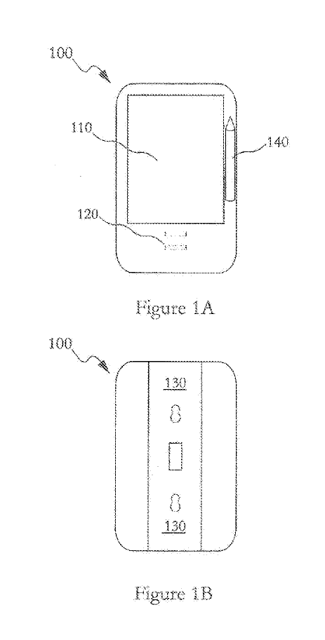

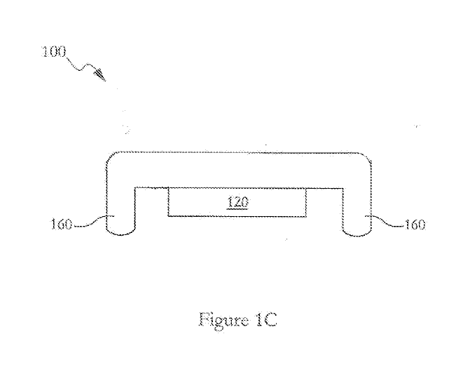

Turning now descriptively to the drawings, referring to FIG. 1, a perspective view of a wall mount cover 100 is shown in accordance with an exemplary embodiment of the present invention. The wall mount cover 100 includes a writing surface 110, a receiving hook 120, and a writing utensil 140. The writing surface 110 may encompass most of the front face of the wall mount cover 100, with the writing utensil 140 positioned next to the writing surface 110. The writing utensil 140 may be attached to the front face of the wall mount cover 100 with a clip, or a hook and loop fastener commonly referred to as Velcro®. The writing surface 110 may be a dry erase board or a notepad for a spiral bound or Post-it® style pad. The writing utensil 140 coordinates with the type of writing surface 110 used, thus a dry erase marker for a dry erase board, and a pen or pencil for a notepad.

The receiving hook 120 may be positioned below the writing surface 110. The receiving hook 120 may be a small hook to receive a user's keys or other small items. Alternatively, the receiving hook 120 may be elongated extending along the width of the writing surface 110 (as illustrated in FIG. 3). With an elongated receiving hook 120 a smart phone may be supported against the wall mount cover 100 as a resting location for the phone. This way the user is able to place their smart phone at a location where it is out of the way, yet easily accessible.

Referring now to FIG. 1B a rear view of the wall mount cover 100 is shown in accordance with an exemplary embodiment of the present invention. The wall mount cover 100 includes a set of screw-remove holes 130. The screw holes 130 enable the user to mount the cover 100 to the wall phone mount for permanent and secure attachment.

Referring now to FIG. 1C a top view of the wall mount cover 100 is shown in accordance with an exemplary embodiment of the present invention. The wall mount cover 100 includes a pair of enclosing sides 160. When a smart phone is place on the receiving hook 120 the enclosing sides 160 assist to ensure that the phone does not fall.

The wall mount cover can be customized with personal decorative accents. The wall mount cover effectively covers a wall mount, transforming an available area into a functional message center. The design of the wall mount cover features the convenience of preserving an unused phone outlet for functional use.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A wall mount cover comprising:
a. a front face;
b. a writing surface disposed on said front face;
c. a writing utensil disposed adjacently to said writing surface;
d. a receiving hook positioned beneath said writing surface; and
e. a set of screw-remove holes on a backside of said wall mount phone cover, where said screw-remove holes enable a user to fasten said cover to a wall mount.

2. The wall mount cover according to claim 1, where said writing surface is a dry erase board.

3. The wall mount cover according to claim 2, where said writing utensil is a dry erase marker.

4. The wall mount cover according to claim 1, where said writing surface is a note pad.

5. The wall mount cover according to claim 4, where said wiring utensil is one of at least a pen and a pencil.

6. The wall mount cover according to claim 4, where said not pad is one of at least a spiral notepad and a Post-it® notepad.

7. The wall mount cover according to claim 1, where the receiving hook is short to receive one of at least keys and small items.

8. The wall mount cover according to claim 1, where the receiving hook is elongated to receive a smart phone.

9. The wall mount cover according to claim 8, where said front face includes a pair of enclosing sides to support said smart phone.
